(19) United States
(12) Patent Application Publication
(10) Pub. No.: US 2009/0019081 A1
(43) Pub. Date: Jan. 15, 2009

(54) INTEGRATING DATA FROM MAPS ON THE WORLD-WIDE WEB

(75) Inventors: Eliyahu Safra, Haifa (IL); Yaron Kanza, Kibbutz Tzuba (IL); Yehoshua Sagiv, Jerusalem (IL); Yerach Doytsher, Raanana (IL)

Correspondence Address: BROWDY AND NEIMARK, P.L.L.C.;624 NINTH STREET, NW, SUITE 300, WASHINGTON, DC, 20001-5303, US

(73) Assignees: Technion Research and Development Foundation Ltd., Technion City (IL); University of Toronto, Toronto (CA); Yissum Technology Transfer Company of the Hebrew University of Jerusalem, Jerusalem (IL)

(21) Appl. No.: 12/170,420

(22) Filed: Jul. 9, 2008

Related U.S. Application Data
(60) Provisional application No. 60/948,524, filed on Jul. 9, 2007.

(51) Int. Cl. G06F 17/30

(52) U.S. Cl. 707/103 R; 707/E17.018

(57) ABSTRACT

A method for integrating digital maps, each containing a plurality of geographical objects. A three-step integration process is presented. First, geographical objects are retrieved from maps on the Web. Secondly, pairs of objects that represent the same real-world entity, in different maps, are discovered and the information about them is combined. Finally, selected objects are presented to the user. The proposed process is efficient, accurate (i.e., the discovery of corresponding objects has high recall and precision) and it can be applied to any pair of digital maps, without requiring the existence of specific attributes.

### FIELD OF THE INVENTION

The present invention relates to data integration, and more particularly to integration of spatial datasets.

### 1. BACKGROUND OF THE INVENTION

Many maps are available on the World-Wide Web, providing information on geographical entities. The information consists of both spatial and non-spatial properties of the entities. Examples of spatial properties are location and shape of an entity. Examples of non-spatial properties are name and address. The goal of integrating two maps is to enable applications and users to easily access the properties that are available in either one of those maps. Another reason for integration is that some geographical entities may appear in only one of the maps. Integration increases the likelihood that for all the relevant entities, in a specified geographical area, objects that represent these entities are presented to the user.

An integration of two maps consists of the following three steps: extracting geographical objects from the maps, discovering pairs of objects that represent the same real-world entity in the two sources (such objects are called corresponding objects) and presenting the result to the user. The present invention relates mainly to the second step of discovering corresponding objects. The term “matching algorithm” as defined herein means an algorithm that discovers corresponding objects in two given datasets of geographical objects.

Methods for integrating data from the Web, and especially matching algorithms, should be able to cope with the following characteristics of the Web.
Data on the Web is heterogeneous. This means that the same piece of information can have different forms in different sources. For example, in different sources, the name of a geographical entity can have different spellings or can be written in different languages. This makes it difficult for integration methods to use properties, such as names, for discovering corresponding objects. Another aspect of heterogeneity is incompleteness. Some attributes may not be available in some sources or not specified for some objects.
Data may change frequently. For example, maps that contain hotels may also include reviews that are regularly added and updated by people who have stayed in those hotels. In such cases, the integration should be performed in real time, i.e., when the user sends her request for information. Otherwise, the integrated data will not reflect the most recent changes in the sources. Consequently, an integration method for data on the Web must be efficient, especially if the method is used in a Web service that handles many requests concurrently.
Data on the Web can be incorrect or inaccurate. Hence, on one hand, integration methods should rely mostly on object properties that are relatively accurate. On the other hand, this justifies using, in Web applications, approximation algorithms for matching, i.e., highly (but not completely) accurate algorithms for discovering corresponding objects.

### SUMMARY OF THE INVENTION

It is an object of the present invention to use properties of integrated objects to increase the effectiveness of location-based matching algorithms.

The present invention relates to a method for integrating a plurality of spatial datasets comprising a plurality of geographical objects. Each geographical object represents a single real-world entity and comprises location information and optionally one or more spatial or non-spatial attributes. The method comprises the steps of: (i) matching groups of two or more geographical objects that represent the same real-word entity in different spatial datasets; and (ii) combining for each of said groups the spatial and/or non-spatial attributes of the two or more geographical objects of the group, available in the plurality of datasets.

The spatial datasets can initially be extracted each from a digital raster graphic such as a map, for example, a digital map on the Internet. Location information can be calculated for each geographical object extracted from a digital raster graphic typically representing a map.

The method of the invention enables displaying on a map (based for example, on one spatial dataset) one or more spatial and/or non-spatial attributes obtained from one or more different spatial datasets.

Matching groups of two or more geographical objects that represent the same real-word entity in different spatial datasets can be done in at least one of the following ways: (i) pre-process detection; (ii) post-process removal; (iii) pre-process distance factorization; or (iv) any combination thereof.

Each attribute can be unique or non-unique. Examples of unique attributes include a name, a telephone number, a Web site etc. Examples of non-unique attributes include the rating (number of stars) of a hotel or restaurant, a field indicating if a hotel has a facility or not (gym, swimming pool, shuttle to the airport etc.).

An attribute may be allowed to have a null value or may not be allowed to have a null value.

The method of the invention also enables displaying on a map a geographical object that only appears in one map.

### BRIEF DESCRIPTION OF THE DRAWINGS

FIG. 1 shows the result of a search in Google Earth for hotels in Soho in New York.

FIG. 2 shows the result of a search in Yahoo Maps for hotels in Soho in New York.

FIG. 3 is a pseudocode for three algorithms according to the invention that receive an existing matching algorithm M and improve it by using the information provided by some specified attributes.

FIG. 4 shows the harmonic mean of the recall and precision (HRP) for the three location-based algorithms according to the invention: nearest-neighbor (NN), mutually-nearest (MUTU) and normalized-weights (NW).

FIG. 5 shows the harmonic mean of the recall and precision for the eight combinations involving each algorithm according to Test I.

FIG. 6 shows the harmonic mean of the recall and precision for the eight combinations involving each algorithm according to Test II.

FIG. 7 shows the performance of the Normalized Weights method for varying levels of completeness and accuracy, wherein the accuracy varies.

FIG. 8 shows the performance of the Normalized Weights method for varying levels of completeness and accuracy, wherein the completeness varies.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

Because data on the Web can be heterogeneous, can change quickly and can be incorrect or inaccurate as described above, the present invention focuses on techniques that start with location-based matching algorithms and improve them. Relying primarily on locations has the following three advantages. First, locations are always available for spatial objects and their degree of accuracy can be determined relatively easily. Hence, location-based matching algorithms can be applied to objects from any pair of maps. Second, location-based methods are suitable for integration of heterogeneous data, since it is easy to compare a pair of locations even when they are stored or measured in different ways. Third, there exist efficient location-based matching algorithms.

Location-based matching algorithms that are both efficient and effective were presented in the past [C. Beeri, Y. Doytsher, Y. Kanza, E. Safra, and Y. Sagiv. Finding corresponding objects when integrating several geo-spatial datasets. In ACM-GIS, pages 87-96, 2005; C. Beeri, Y. Kanza, E. Safra, and Y. Sagiv. Object fusion in geographic information systems. In VLDB, pages 816-827, 2004]. These algorithms use only locations for finding corresponding objects. Yet, in many cases, the accuracy of the integration can be improved significantly by using attributes of the integrated objects in addition to locations. This is especially important when dealing with data from the Web, where locations may be inaccurate.

In order to integrate data from maps on the World-Wide Web according to the invention, several steps need to be followed. First, the present description discloses a complete process of integrating data from maps on the Web. This process is efficient and general, in the sense that it can be applied to any pair of maps. Secondly, in addition to locations, attributes of the objects can be used in the integration process. Specifically, the present invention discloses three new matching algorithms that use locations as well as additional information. Thirdly, in order to illustrate the effectiveness of the invention, we disclose the results of thorough experiments, on datasets with different levels of accuracy and completeness, showing that additional information can improve the results of location-based matching algorithms, when that information is used appropriately.

The structure of this document is as follows. Section 2 presents the methods of the invention using a real-world example of integrating maps of hotels in the Soho area of Manhattan, N.Y. Section 3 presents the three new methods of the invention. Section 4 provides the results of experiments that were conducted on both real-world data and syntactically generated data. Also, the methods are compared based on the experimental results. Finally, Section 5 discuses related work and concludes.

### 2. THE INTEGRATION PROCESS

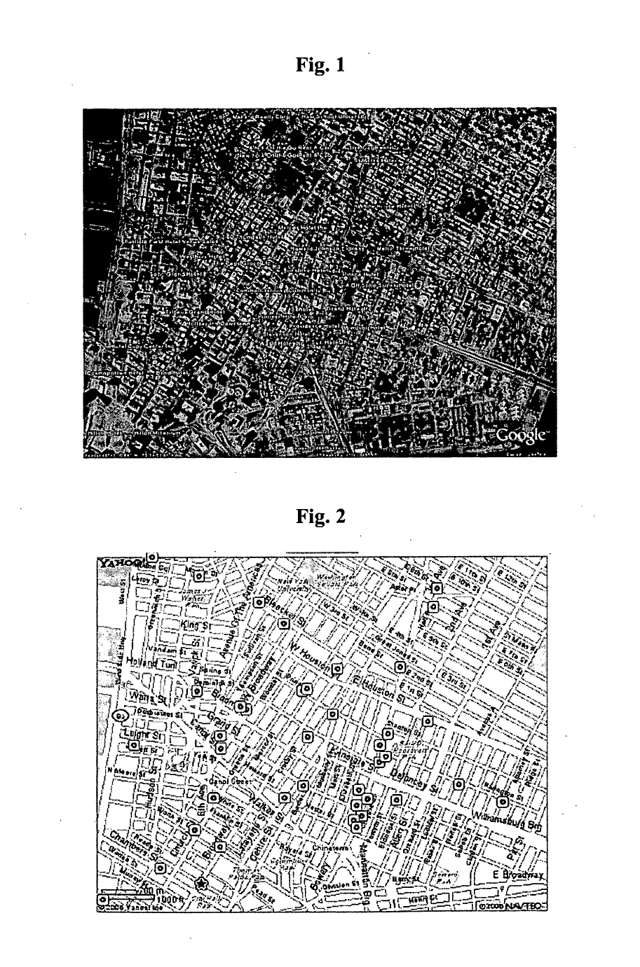

In order to present an embodiment of integration of data from maps on the Web, an example is shown below that shows integration of information about hotels in the Soho area of Manhattan, N.Y. The data sources that were used are Google Earth® (http://earth.google.com), Google® and Google Earth® (registered trademark of Google, Inc. from Mountain View, Calif., United States); and Yahoo Maps® (http://maps.yahoo.com), Yahoo!® and Yahoo! Maps® (registered trademarks of Yahoo!, Inc. from Sunnyvale, Calif., United States). Google Earth is a service that provides a raster image of almost any part of earth. A raster image is bit map image, a picture depicted by pixels of different colors. On top of the raster image, Google Earth shows information such as roads, hotels, and restaurants. In our example, we are interested in information about hotels. For hotels, Google Earth provides their names, which are shown as links that lead to additional information, e.g., by following a link the address of the hotel is provided. A result of a search in Google Earth for hotels in Soho is depicted in FIG. 1.

Yahoo Maps provides road maps for some major cities in the world. As in Google Earth, maps include touristic information; however, in Yahoo, hotel names are not presented on the maps. Instead, a hotel is shown using an icon in the shape of a yellow square containing a red circle. The name of the hotel and additional information, such as the rank (i.e., number of stars) and price are available for one hotel at a time, by clicking on the icon. Two possible reasons for not writing hotel names on the map are (1) making the presentation of the map simpler and easier to read (cartographic reasons), and (2) restricting the information released per each user request, so that applications will not be able to retrieve all the data from Yahoo to their local database (commercial reasons). A result of a search in Yahoo Maps for hotels in Soho is depicted in FIG. 2.

In the hotel scenario, it may seem a good solution to use a matching algorithm that considers as corresponding objects those pairs of hotels that have the same name. However, because names of hotels are not presented on maps from Yahoo, a matching based on names is problematic. Two other difficulties in using hotel names in a matching algorithm are the uncertainty in deciding whether two names refer to the same hotel and the presence of errors in the data. In our case, uncertainty is due to the existence of several hotels with similar names in the same vicinity. For instance, consider the following hotel names: “Grand Hotel,” “Soho Grand Hotel” and “Tribeca Grand Hotel.” Are these the names of three different hotels or of only two different hotels? Another case of uncertainty is when a hotel has more than one name. In the Soho area, the hotel named “Howard Johnson Express Inn,” according to Google Earth, is named “Metro Three Hotel LLC” in Yahoo Maps, and indeed these are two names of the same hotel.

In one embodiment of the present invention, the following three-step integration process is proposed: (1) Retrieve the maps, extract relevant objects from the maps and compute the location of the objects; (2) Apply a matching algorithm for finding pairs of corresponding objects; and (3) Display objects to the user (or return them as a dataset), where each pair of corresponding objects is represented by a single object. Objects that do not belong to any pair of corresponding objects may also be presented.

We now illustrate these steps using the Soho-hotels scenario. Initially, a search for hotels in Soho, N.Y., was made in both Google Earth and Yahoo Maps, and the images of FIG. 1 and FIG. 2 were retrieved as a result. These two images were oriented using geo-referencing. Then, geographical objects were generated by digitizing the maps that is, by identifying (in the raster images) icons of hotels and calculating their locations based on the geo-referencing. In this example, hotel names were inserted by a human user. In the future, we expect many maps on the Web to be in formats that computers can easily process without the need of human intervention. Geographic Markup Language (GML) described in http://www.opengeospatial.org/standards/gml is an example of such a format.

The second step was to apply a matching algorithm to the two datasets that were extracted from the maps. The result of this step consists of pairs of objects that represent the same hotel, and of singletons representing hotels that appear in only one of the sources. More details about the matching algorithm will be given in the next section. The final step of the integration is displaying to the user the pairs and singletons produced by the matching algorithm. Before providing the results, conditions can be used for selecting which objects to display. Note that filtering the results at this step makes it possible to apply conditions that use attributes from both sources.

### 3 MATCHING ALGORITHMS

The most involved part of an integration process is the discovery of corresponding objects, i.e., the matching algorithm. Several matching algorithms that use only the location of objects were proposed in the past [C. Beeri, Y. Doytsher, Y. Kanza, E. Safra, and Y. Sagiv. Finding corresponding objects when integrating several geo-spatial datasets. In ACM-GIS, pages 87-96, 2005; C. Beeri, Y. Kanza, E. Safra, and Y. Sagiv. Object fusion in geographic information systems. In VLDB, pages 816-827, 2004]. Three new algorithms that are built upon existing location-based algorithms and use attributes of objects for improving the matching are now described.

3.1 Framework

First, the framework of the invention is present. A dataset is a collection of geographical objects that are extracted from a given map. Each object represents a single real-world geographical entity and has a point location. (For an object that has a polygonal shape, we consider the center of mass of the polygonal shape to be the point location of the object.) The distance between two objects is the Euclidean distance between their point locations. We denote by distance(a, b) the distance between two objects a and b.

An object may have, in addition to location, attributes that contain information about the entity that the object represents. We distinguish between two types of attributes. An attribute I of objects in a dataset A is unique if every two objects in A have different values for I, i.e., I is a candidate key. We consider I as non-unique if there can be two objects in A that have the same value for I. For example, in a dataset of hotels, the name of a hotel is a unique attribute, since it is unlikely that two hotels in the same vicinity will have the same name. We consider rating (number of stars) as non-unique, because two proximate hotels may have the same number of stars. When locations of objects are not accurate, we can improve a basic matching algorithm by using additional attributes.

If the additional information is correct, a unique attribute can be used for discovering pairs of corresponding objects that the basic algorithm fails to match. Both unique and non-unique attributes can be used for detecting pairs of non-corresponding objects that are, wrongly, deemed corresponding by a matching algorithm.

In integration of maps, locations of objects are not accurate, because the process of extracting objects and computing their locations, by digitizing an image, introduces errors. Furthermore, maps on the Web may not be accurate to begin with. Thus, given two datasets A and B that are extracted from two maps, two corresponding objects a ε A and b ε B may not have the same location. Yet, for each dataset, errors are normally distributed with some standard deviation σ. So, for 98.8% of the objects, their distance from the real-world entity that they represent is less than or equal to 2.5σ. Hence, for 98.8% of the pairs {a, b} of corresponding objects, it holds that distance(a, b)≦β, where β=2.5\sqrt{σ_{A}²+σ_{B}²} is the distance bound of A and B (σ_{A} and σ_{B} are the standard deviations of the error distributions in A and B, respectively). In our algorithms, pairs {a, b} with distance(a, b)>β are never deemed corresponding objects.

A matching algorithm receives a pair of datasets A and B and returns two sets P and S. The set P consists of pairs {a, b}, such that a ε A and b ε B are likely to be corresponding objects. The set S consists of singletons {s} (where s ε A∪B) such that, with high likelihood, s does not have a corresponding object. Location-based matching algorithms compute the sets P and S according to the distance between objects.

3.2 The New Matching Algorithms

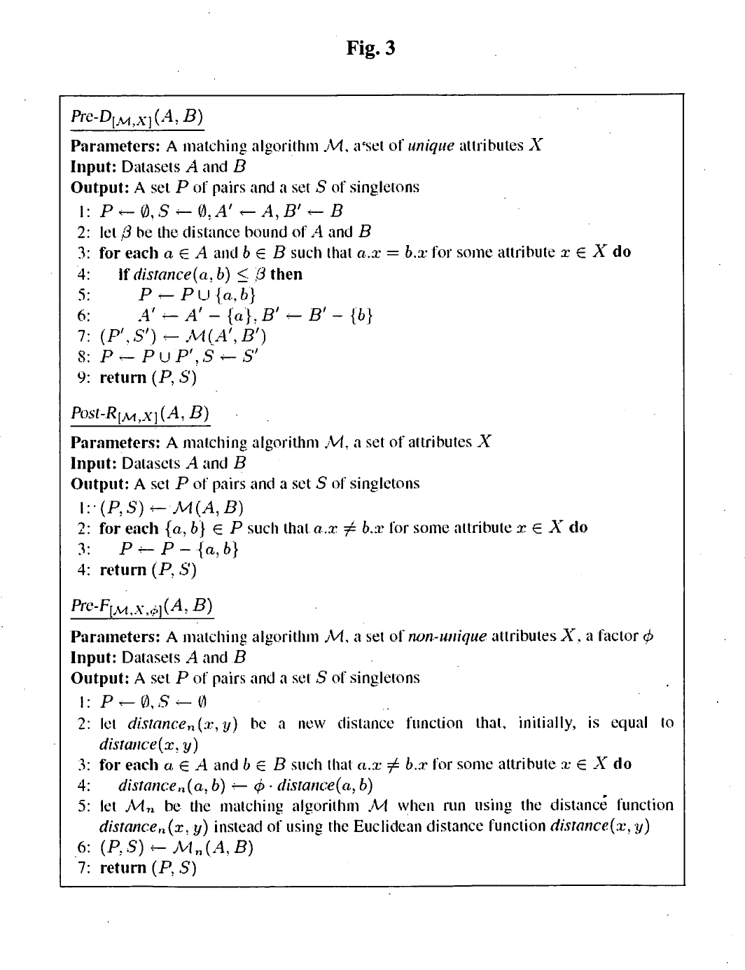

We now describe three new algorithms that receive an existing matching algorithm M and improve it by using the information provided by some specified attributes. We divide the input to these algorithms into two parts. One part consists of two datasets A and B that should be joined. The second part consists of M, a set X of the given attributes and, for the third algorithm, an additional factor φ. We denote by P and S the set of pairs and the set of singletons, respectively, that the algorithms return. The pseudocode of all three algorithms is presented in FIG. 3.

Pre-Process Detection (Pre-D)

The Pre-D algorithm uses unique attributes for detecting corresponding objects, and then it calls another matching algorithm on the remaining objects. The algorithm has two steps.

1. For each pair of objects a ε A and b ε B, such that a and b have the same value for some unique attribute of X and the distance between them does not exceed the distance bound of A and B, the pair {a, b} is added to P, a is removed from A and b is removed from B.

2. The matching algorithm M is applied to the remaining objects of A and B. Upon termination, the pairs of the result are added to P and the singletons to S.

Post-Process Removal (Post-R)

The Post-R algorithm uses a set of attributes X for detecting pairs of objects that are erroneously matched by another algorithm. The Post-R algorithm has two steps.

1. The matching algorithm M is applied to A and B. The result is a set P of pairs and a set S of singletons.

2. For each pair of objects {a, b} in P, such that a and b have different values for some attribute of X, the pair {a, b} is removed from P.

Pre-Process Distance Factorization (Pre-F)

The Pre-F algorithm uses a set X of non-unique attributes as follows. For every pair of objects a ε A and b ε B that have different values for some attribute of X, the distance between a and b is multiplied by the given factor φ>1. Note that increasing the distance between objects lowers the probability that they will be matched by a location-based algorithm. The algorithm Muses the new distances to join A and B.

In our experiments, we tested eight different combinations of the above algorithms. Suppose that the set Y contains the shared attributes of two datasets A and B. Let unique(Y) and non-unique(Y) be the sets of unique and non-unique attributes of Y, respectively. Given a location-based matching algorithm M, the following are the eight possible ways of computing the matching of A and B.

1. Use only the location based algorithm M, i.e., return M(A,B).

2. Use Post-R with M. That is, return Post-R_{[M,Y]}(A,B).

3. Use Pre-D with M. That is, return Pre-D_{[M,unique(Y)]}(A, B).

4. Combine Pre-D and Post-R, i.e., return Post-R_{[Pre-D}_{_{[M,unique(Y)]}}^{,Y]}(A, B).

5. Use Pre-F with M. That is, return Pre-F_{[M,non-unique(Y),φ]}(A,B).

6. Combine Post-R with Post-R_{[Pre-F}_{_{[M,non-unique(Y),φ]}}^{,Y]}(A, B).

7. Combine Pre-D with Pre-F. That is, return the result of the following expression: Pre-D_{[Pre-F}_{_{[M,non-unique(Y),φ]}}_{,unique(Y)]}(A, B).

8. Combine all the three methods by applying Pre-F, Pre-D, M and, finally, Post-R, i.e., return

$$Post \text{-} {R}_{[ Pre \text{-} {D}_{[ Pre \text{-} {F}_{[ M , non \text{-} unique ( Y ) , φ ]} , unique ( Y ) ]} , Y ]} ( A , B ) .$$

3.3 Computing the Distance Bound

Applying a matching algorithm requires knowing the distance bound β (or an approximation of it). The approximation of β is computed based on approximations of σ_{A} and σ_{B}—the standard deviations of the error distributions in the integrated datasets (see Section 3.1). The values σ_{A} and σ_{B} (we also call them the errors of the datasets) are sometimes provided with the maps, and in other cases are needed to be estimated.

The error of a dataset is caused by errors in the procedure of collecting and processing the geographical data. The procedure is different when generating raster (bitmap, imagery) maps and when vector (feature based) maps are produced. See [J. C. McGlone. Manual of Photogrammetry, Fifth Edition. American Society of Photogrammetry and Remote Sensing, 2004] for more detailed descriptions of these procedures.

Raster maps are typically generated from satellite or aerial photographs. There are three main causes of error in the process of creating raster maps. First, errors are introduced when the photos are orthorectified i.e., when correcting the photos to accurately represent the surface of the earth. Second, the size of the pixels in the photo affects the error. Currently, a resolution of 70 cm per pixel at nadir is common in satellite imagery (e.g., in the two main high-resolution commercial earth-observation satellites IKonos and QuickBird). The first two factors are relatively small and the main cause of error is the third factor which is the accuracy of the geo-referencing process i.e., the accuracy of matching earth coordinates to the imagery. The accuracy of the geo-referencing depends on the existence and accuracy of reference points. When no reference points exist, the accuracy is about 10 meters, while when there are reference points, the accuracy is about 1-10 meters, depends on the accuracy of the reference points. Extracting features from the raster image (e.g., identifying the location of a hotel) also introduces an error which is approximately the number of pixels of the error in the extraction process multiplied by the resolution.

Vector maps are usually created either by governmental mapping agencies, or by commercial companies, according to agreed mapping standards. The standards define accuracy requirements that depend on the map scale. Typically, for urban areas, map scales are between 1/1000- 1/10000. Normally, the required accuracy for such scales is about 0.3-0.4 mm. For example at a scale of 1/5000, the error is about 1.5-2 meters.

3.4 Measuring the Quality of the Result

We use recall and precision to measure the accuracy of a matching algorithm. As mentioned above, the result of a matching algorithm consists of sets (singletons and pairs). A set is correct if it is either a pair of corresponding objects or a single object that has no corresponding object. Given the result of a matching algorithm, the recall is the ratio of the number of correct sets in the result to the number of all correct sets. For example, a recall of 0.8 means that 80% of the correct sets appear in the result. The precision is the ratio of the number of correct sets in the result to the number of sets in the result. For example, a precision of 0.9 means that 90% of the sets in the result are correct.

In our experiments, we knew exactly which sets were correct and, hence, were able to determine the precision and recall. For synthetic data, all the information about the data was available to us. For real-world data, we determined the correct sets manually, using all the available information.

### 4 EXPERIMENTS

In this section, we describe the results of extensive experiments on both real-world and synthetically generated data. The goal of our experiments was to compare the eight combinations, presented in Section 3.2, over data with varying levels of inaccuracy and incompleteness. We also wanted to determine by how much our methods improve existing location-based algorithms. For that, we tested the effect of our methods on the following three location-based algorithms: nearest-neighbor (NN), mutually-nearest (MUTU) and normalized-weights (NW); see [C. Beeri, Y. Kanza, E. Safra, and Y. Sagiv. Object fusion in geographic information systems. In VLDB, pages 816-827, 2004] for a description of these algorithms.

4.1 Tests on Real-World Data

We present the results of integrating the maps of hotels in Soho as described in Section 2. The Google-Earth map presents 28 hotels and the map from Yahoo Maps presents 39 hotels and inns. A total number of 44 hotels and inns appear in these sources, where 21 hotels appear in both of the sources while 23 appear in only one source. For both sources, we used an error σ of 100 meters because identifying the location of a hotel based on an icon is highly inaccurate.

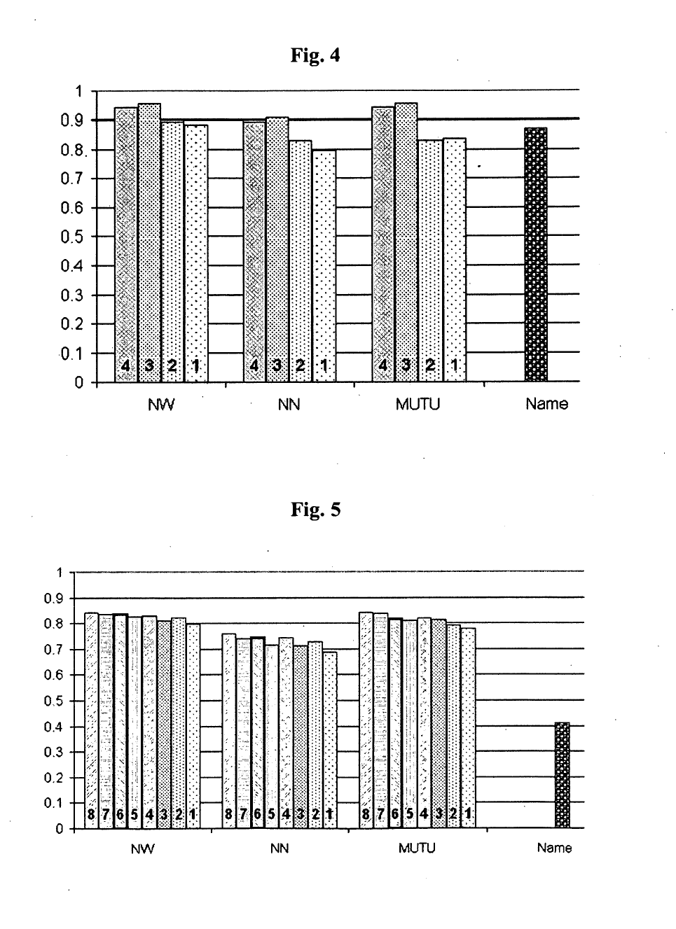

FIG. 4 shows the harmonic mean of the recall and precision (HRP) for the three location-based algorithms (NW, MUTU, NN). Each one of the three algorithms was tested according to the first four combinations of Section 3.2. (The other four combinations are not applicable, since the only attribute, hotel name, is unique.) The third combination, Pre-D, is clearly the best for each of the three algorithms. It is slightly better than the fourth combination, which includes both Pre-D and Post-R, since the attribute hotel name is not always accurate (e.g., one hotel has different names in the two sources). For comparison, FIG. 4 also shows the result of matching just according to hotel names. Note that for combinations 2-4, the process was semi-automatic, since hotel names do not appear in Yahoo Maps. The harmonic mean H of the positive real numbers a₁, a₂, . . . , aₙ is defined to be

$$H = \frac{n}{\frac{1}{{a}_{1}} + \frac{1}{{a}_{2}} + … + \frac{1}{{a}_{n}}} = \frac{n}{{\sum }_{i = 1}^{n} \frac{1}{{α}_{i}}}$$

4.2 Tests on Synthetic Data

In order to test our methods on data with varying levels of accuracy and incompleteness, we randomly generated synthetic datasets using a two-step process. First, the real-world entities are generated. The locations of these entities are randomly chosen, according to a uniform distribution, in a square area. Each entity has one unique attribute U and one non-unique attribute N with randomly-chosen values. The non-unique attribute has five possible values (as for the number of stars of a hotel). In the second step, the objects in each dataset are generated. Each object is associated with a distinct entity and its location is chosen with an error that is normally distributed (relative to the location of the entity). In each dataset, different objects correspond to distinct entities. For each object, the attribute U has either the same value as in the corresponding entity, null (for incompleteness) or an arbitrary random value (for inaccuracy). We denote by c(U) the percentage of objects that have a non-null value for U and by a(U) the percentage of objects that have either the correct value or null. Values are similarly assigned to N.

We present the results of two tests. In Test I, the values of the attributes are either accurate or missing (i.e., null). In Test II, all the objects have values for U and N, but some of those values are inaccurate. In both tests, there are 1000 entities in a square area of 1350×1350 meters with a minimal distance of 15 meters between entities. Each dataset has 750 objects that are randomly chosen for 750 entities using a standard deviation of σ=12 meters for the error distribution. In Test I, the attributes in each dataset have either the correct values or nulls as follows: a(U)=a(N)=100%, c(U)=40% and c(N)=60%. That is, only 40% of the objects have the correct value for the unique attribute and only 60% of the objects have the correct value for the non-unique attribute (if the value is not the correct one, then it is null). In Test II, attributes always have non-null values but not necessarily the correct ones, i.e., c(U)=c(N)=100% and a(U)=a(N)=80%.

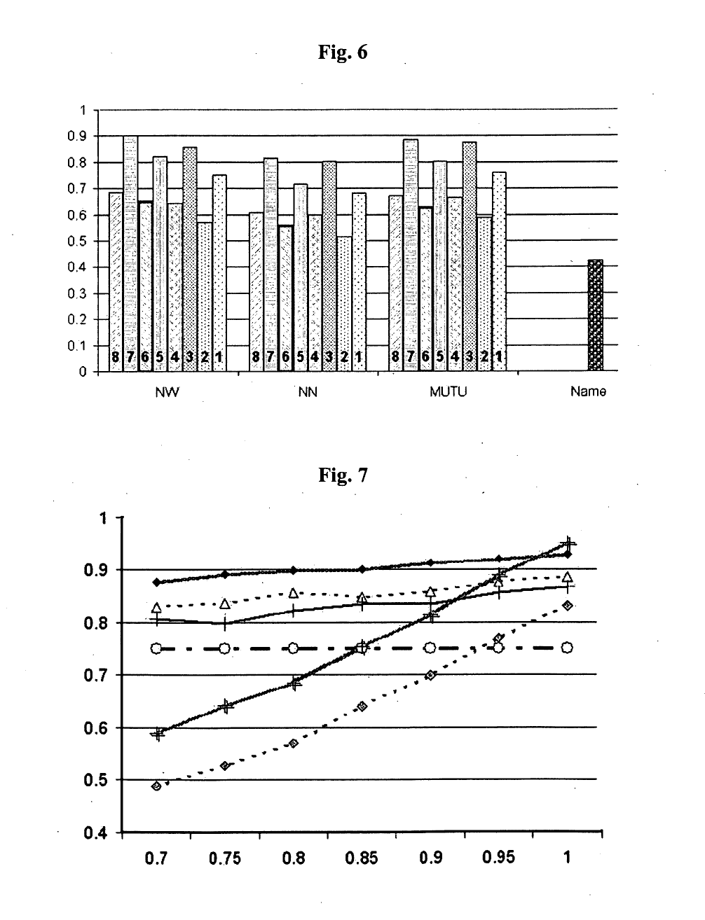

In Test I and Test II, we tried the eight combinations of Section 3.2 with each of the three algorithms. The results, depicted in FIG. 5 and. FIG. 6, show the harmonic mean of the recall and precision for the eight combinations involving each algorithm. Each bar is for the combination identified by the number on that bar. For comparison, we also show the result obtained by a matching algorithm that only uses the unique attribute (Name).

Test I shows that when information is partial but accurate, the eighth combination that uses all of the three algorithms (Pre-D, Post-R and Pre-F) is the best. Test II shows that when information is inaccurate, Post-R is not effective (as was also the case for the real-world data) and it is better to use just Pre-D and Pre-F (the seventh combination).

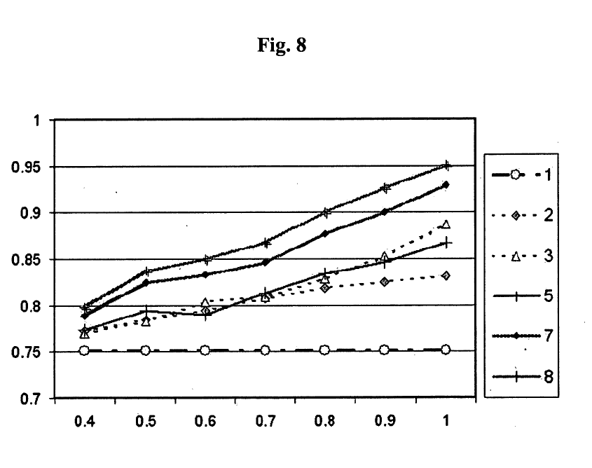

FIGS. 7 and 8 show the performance of the NW method for varying levels of completeness and accuracy. In FIG. 7, the accuracy varies, i.e., a(U)=a(N)=70% . . . 100%, and the completeness is fixed, i.e., c(U)=c(N)=100%. In FIG. 8, the completeness varies, i.e., c(U)=c(N)=40% . . . 100%, and the accuracy is fixed, i.e., a(U)=a(N)=100%. In each graph, the serial number refers to the combination that produced the graph. Note that the results of only 6 methods (1, 2, 3, 5, 7, 8) are presented, since the other two are inferior.

The followings are our conclusions from the tests.

1. When there is a unique attribute, it is always good to identify pairs and remove them from the matching algorithm (Method 2).

2. When there is a non-unique attribute, it is always good to use factorized distance (Method 5).

3. Although additional information improves the quality of the results, the main factor that determines the quality is still the location-based algorithm.

4. When the attributes are not accurate, using the additional information before the matching improves the quality of the result. But using it after the location-based matching has a negative effect, for the following reason. While there is only a low probability that two proximate yet non-corresponding objects have the same value for a unique attribute, there is a considerably higher probability that two corresponding objects have different values for some unique attribute.

The tests show that in all cases using additional attribute before applying a location-based matching algorithm improves the quality of the results. Applying additional information at the end yields an improvement only if that information is accurate.

### 5 CONCLUSIONS

Traditionally, integration of geo-spatial data is being done using map conflation [A. Saalfeld. Conflation-automated map compilation. IJGIS, 2(3):217-228, 1988; M. A. Cobb, M. J. Chung, H. Foley, F. E. Petry, and K. B. Show. A rule-based approach for conflation of attribute vector data. GioInformatica, 2(1):7-33, 1998]. However, map conflation is not efficient since whole maps are integrated, not just selected objects. Thus, conflation is not suitable for Web applications or in the context of mediators [O. Boucelma, M. Essid, and Z. Lacroix. A WFS-based mediation system for GIS interoperability. In ACM-GIS, pages 23-28, 2002; Y. Papakonstantinou, S. Abiteboul, and H. Garcia-Molina. Object fusion in mediator systems. In VLDB, pages 413-424, 1996; G. Wiederhold. Mediators in the architecture of future information systems. Computer, 25(3):38-49, 1992; G. Wiederhold. Mediation to deal with heterogeneous data sources. In Introperating Geographic Information Systems, pages 1-16, 1999] where users request answers to specific queries. Integrating spatial datasets using only geometrical or topological properties [C. Beeri, Y. Doytsher, Y. Kanza, E. Safra, and Y. Sagiv. Finding corresponding objects when integrating several geo-spatial datasets. In ACM-GIS, pages 87-96, 2005; C. Beeri, Y. Kanza, E. Safra, and Y. Sagiv. Object fusion in geographic information systems. In VLDB, pages 816-827, 2004; A. Samal, S. Seth, and K. Cueto. A feature based approach to conflation of geospatial sources. IJGIS, 18(00):1-31, 2004] or using only alpha numeric attributes [L. Gravano, P. G. Ipeirotis, H. V. Jagadish, N. Koudas, S. Muthukrishnan, and D. Srivastava. Approximate string joins in a database (almost) for free. In VLDB, pages 491-500, 2001; L. Gravano, P. G. Ipeirotis, N. Koudas, and D. Srivastava. Text joins in an RDBMS for web data integration. In Proceedings of the 12^{th} international conference on World Wide Web, pages 90-101, 2003], both do not use all the available information but can be combined by any person skilled in the art using the approach of the invention described above.

Other approaches use both spatial and non-spatial attributes (e.g. [T. Devogele, C. Parent, and S. Spaccapietra. On spatial database integration. In IJGIS, Special Issue on System Integration, 1998; M. Sester, K. H. Anders, and V. Walter. Linking objects of different spatial data sets by integration and aggregation. GeoInformatica, 2(4):335-358, 1998; V. Walter and D. Fritsch. Matching spatial data sets: a statistical approach. IJGIS, 13(5):445-473, 1999]). However, these approaches occasionally remain on the schema level, rather than actually matching the objects, such as [T. Devogele, C. Parent, and S. Spaccapietra. On spatial database integration. In IJGIS, Special Issue on System Integration, 1998], or has large computation time as [M. Sester, K. H. Anders, and V. Walter. Linking objects of different spatial data sets by integration and aggregation. GeoInformatica, 2(4):335-358, 1998; V. Walter and D. Fritsch. Matching spatial data sets: a statistical approach. IJGIS, 13(5):445-473, 1999].

We showed how data from maps on the Web can be integrated using location-based algorithms, and how to utilize information additional to location when such information exists. We presented three new matching algorithms and tested them on data with varying levels of incompleteness and inaccuracy. Interestingly, our experiments show that when the additional information is accurate it should be used both before and after the location-based matching process. When the additional information is not very accurate, the information should be used only prior to the location-based matching process. Our experiments show that the new algorithms improve the existing location-based matching algorithms.

Although the invention has been described in detail, nevertheless changes and modifications, which do not depart from the teachings of the present invention, will be evident to those skilled in the art. Such changes and modifications are deemed to come within the purview of the present invention and the appended claims.

1. A method for integrating a plurality of spatial datasets comprising a plurality of geographical objects, wherein each geographical object represents a single real-world entity and comprises location information and optionally one or more spatial or non-spatial attributes, said method comprising the steps of:
(i) matching groups of two or more geographical objects that represent the same real-word entity in different spatial datasets; and
(ii) combining for each of said groups the spatial and/or non-spatial attributes of said two or more geographical objects of the group, available in said plurality of datasets.

2. A method according to claim 1, further containing an initial step of extracting each spatial dataset from a digital raster graphic.

3. A method according to claim 2, further containing the step of calculating location information for each geographical object extracted from said digital raster graphic.

4. A method according to any of claims 1 to 3, further containing the step of displaying on a map one or more spatial and/or non-spatial attributes obtained from a different spatial dataset.

5. A method according to claim 1, wherein the matching in step (i) is done in at least one of the following ways:
(i) pre-process detection;
(ii) post-process removal;
(iii) pre-process distance factorization; or
(iv) any combination thereof.

6. A method according to claim 1, each attribute can be either unique or non-unique.

7. A method according to claim 1, each attribute may or may not have a null value.

8. A method according to claim 1, further containing the step of displaying on a map a geographical object that only appears in one different map.

9. A computer-readable medium encoded with a program module that integrates a plurality of spatial datasets comprising a plurality of geographical objects, wherein each geographical object represents a single real-world entity and comprises location information and optionally one or more spatial or non-spatial attributes, by:
(i) matching groups of two or more geographical objects that represent the same real-word entity in different spatial datasets; and
(ii) combining for each of said groups the spatial and/or non-spatial attributes of said two or more geographical objects of the group, available in said plurality of datasets.

10. A medium according to claim 9, further containing an initial step of extracting each spatial dataset from a digital raster graphic.

11. A medium according to claim 10, further containing the step of calculating location information for each geographical object extracted from said digital raster graphic.

12. A medium according to any of claims 9 to 11, further containing the step of displaying on a map one or more spatial and/or non-spatial attributes obtained from a different spatial dataset.

13. A medium according to claim 9, wherein the matching in step (i) is done in at least one of the following ways:
(i) pre-process detection;
(ii) post-process removal;
(iii) pre-process distance factorization; or
(iv) any combination thereof.

14. A medium according to claim 9, each attribute can be either unique or non-unique.

15. A medium according to claim 9, each attribute may or may not have a null value.

16. A medium according to claim 9, further containing the step of displaying on a map a geographical object that only appears in one different map.
